(19) United States
(12) Patent Application Publication
(10) Pub. No.: US 2009/0258191 A1
(43) Pub. Date: Oct. 15, 2009

(54) Shrink film laminates

(75) Inventor: Andrew J. Peacock, Richmond, VA (US)

Correspondence Address: Tessari & Associates, PLLC, 215 N. Olive Sreet, Media, PA, 19063, US

(73) Assignee: Tredegar Film Products Corporation, Richmond, VA (US)

(21) Appl. No.: 12/384,000

(22) Filed: Mar. 31, 2009

Related U.S. Application Data
(60) Provisional application No. 61/124,218, filed on Apr. 15, 2008.

(51) Int. Cl. B32B 3/30; B32B 37/00

(52) U.S. Cl. 428/167; 156/290

(57) ABSTRACT

Heat shrink laminates comprising at least one non-elastic film layer and at least one other layer, which can be a film or a fibrous nonwoven layer are disclosed wherein the non-elastic film layer and the at least one other layer are bonded together by a plurality of spaced-apart bond points, wherein the non-elastic film layer is heat shrunk after bonding to shrink the film layer and cause the other layer to form pleats.

### BACKGROUND OF THE DISCLOSURE

The disclosure is related to a laminate containing a layer of a shrink film and at least one other layer attached thereto. The other layer may comprise a film or a nonwoven fabric web. More particularly, the disclosure is related to a laminate that is bulked and dimensionally stabilized.

Laminates comprising multiple film layers or film layers and fibrous webs are well known and used for many different purposes. For example, disposable absorbent articles, such as diapers and feminine hygiene products, employ liquid impermeable laminates of a film and a nonwoven fabric as a backsheet. Laminates of film and nonwoven material are also employed as housewrap products and for other uses.

Shrink film laminates are also known in the art. Shrink film laminates are laminates containing a heat-shrink film and, typically, a fibrous material. After formation of the laminate, the laminate is heated to shrink the film, causing the fibrous layer to form puckers and pleats. Such materials, exemplified by U.S. Pat. No. 3,959,051; U.S. Pat. No. 5,814,178; U.S. Pat. No. 5,536,555 and U.S. Pat. No. 6,809,048, are used for hygiene articles (diapers, feminine hygiene pads, etc.) or as carpet backing layers. In addition, shrink film elastic laminates are also known and used particularly in hygiene articles. In such shrink film elastic laminates, the film layer comprises an elastomeric resin. Once heat activated, the film layer becomes elastic, providing stretch and recovery properties to the laminate. Shrink film elastic laminates are mentioned, for example, in U.S. Pat. No. 5,151,092.

### SUMMARY OF THE DISCLOSURE

The present disclosure provides a process for producing a three dimensionally texturized film laminate having a film layer and at least one other layer, wherein the film layer has a higher latent shrinkability than the other layer. The process has the steps of placing the two layers and optionally additional layers in juxtaposition, attaching the layers together at a plurality of spaced-apart bond locations to form a laminate, heating the bonded laminate to a temperature that activates the latent shrinkability of the film layer, and allowing the heated laminate to retract such that the film layer shrinks and said other layers form gathers between said bond locations, thereby forming a three dimensional texture, and heat annealing the laminate.

In one embodiment, the laminate comprises a shrink film layer and at least one fibrous layer, preferably a fibrous nonwoven fabric web. In another embodiment, the laminate comprises a shrink film layer sandwiched between two fibrous layers. In still another embodiment, the laminate comprises shrink film layers bonded to either surface of a nonwoven fabric web to form a shrink film/nonwoven fabric/shrink film laminate. In another embodiment, the laminate comprises a shrink film layer and a non-shrink film layer.

The film layer(s) used in the laminates are nonelastic, which means that the film, if stretched to 125% of its original length, will not recover more than 40% of its additional stretched length upon release of the stretching force. The layers of the laminate are joined at a multitude of spaced-apart bond sites, and the laminate is heat annealed, wherein the fibrous layer forms gathers between spaced-apart bond sites to provide the three dimensional texture.

Term “meltblown fibers” refers to fibers formed by extruding a molten thermoplastic material through a plurality of fine, usually circular, capillaries as molten threads or filaments into a high velocity gas (e.g., air) stream that attenuates the filaments of molten thermoplastic material to reduce their diameter, which may be to a microfiber diameter. The term “microfibers” refers to small diameter fibers having an average diameter not greater than about 100 microns. Thereafter, the meltblown fibers are carried by the high velocity gas stream and are deposited on a collecting surface to form a web of randomly dispersed meltblown fibers.

The term “spunbonded fibers” refers to small diameter fibers that are formed by extruding a molten thermoplastic material as filaments from a plurality of fine, usually circular, capillaries of a spinneret with the diameter of the extruded filaments then being rapidly reduced as by, for example, eductive drawing or other well-known spunbonding mechanisms.

The term “unitary web” refers to a layered web comprising two or more webs of material, including nonwoven webs that are sufficiently joined, such as by thermal bonding means, to be handled, processed, or otherwise utilized, as a single web.

The terms “laminate” and “composite”, when used to describe webs of the present disclosure, are synonymous. Both refer to a web structure comprising at least two webs joined in a face to face relationship to form a multiple-layer unitary web.

The term “polymer” includes homopolymers, copolymers, such as, for example, block, graft, random and alternating copolymers, terpolymers, etc., and blends and modifications thereof. Furthermore, unless otherwise specifically limited, the term “polymer” is meant to include all possible stereochemical configurations of the material, such as isotactic, syndiotactic and random configurations.

The term “substantially” means that a given property or parameter may vary by about 20% from the stated value.

The term “apertured formed film” refers to a film with apertures or holes in the film, usually in a repeating pattern, produced by subjecting the film to a vacuum or high pressure water jets to rupture the film in predetermined locations, as described in U.S. Pat. No. 4,456,570 to Thomas or U.S. Pat. No. 3,929,135 to Thompson, among others.

The fibrous layer is a coherent web structure that can readily be handled initially without significant separation of the fibers from one another, so that the web does not disintegrate or break into fibers.

### BRIEF DESCRIPTION OF THE DRAWING FIGURES

FIG. 1 is a perspective view of a process of forming a laminate in accordance with the disclosure.

FIG. 2 is a sectioned side view of a laminate in accordance with the disclosure.

FIG. 3 is a sectioned side view of another embodiment of a laminate in accordance with the disclosure.

### DETAILED DESCRIPTION

The disclosure provides a three dimensionally texturized film laminate containing at least one shrink film layer and at least one other layer bonded to the shrink film layer. The at least one other layer can comprise a film layer or a fibrous layer. When a fibrous layer is used, it is preferred that the fibrous layer be a fibrous nonwoven fabric web.

In accordance with the disclosure, the shrink film layer and the at least one other layer are placed in surface-to-surface contact and bonded to impart spaced-apart bond sites, forming a unitary laminate, and then the laminate is thermally annealed to shrink the film layer, texturizing and heat stabilizing the laminate.

The laminate provides highly desirable properties including improved loft, texture and appearance. In addition, the laminate is heat stabilized and is dimensionally stable such that the laminate can be used even in various applications in which the laminate is exposed to a relatively high temperature, such as steam sterilization. More specifically, the three dimensionally texturized laminate in general is thermally stable up to the annealing temperature of its production process.

The shrink film laminates comprise a shrink film intermittently bonded to one or more additional layers. When the laminate is rapidly heated to a temperature around the melting point of the film, but below the melting point of the other layer, the film shrinks causing the non-shrink film layer(s) between bond points to fold. If uniaxial shrink film is employed, the non-shrink film layer adopts a series of essentially parallel pleats. If the film shrinks bi-axially, the non-shrink film layer is forced into a quilted configuration. At high shrinkage levels the number of folds per inch reaches a point where the majority of the nonwoven fabric is forced into the “Z” direction; i.e., essentially perpendicular to the plane of the film. Under these conditions the pleats support each other, creating a high loft structure.

In embodiments comprising only two layers—a single shrink film layer and a single non-shrink film layer—the laminates tend to curl as the film shrinks. However, this phenomenon can be addressed by constraining the laminate during shrinkage—such as would likely be the case in making the laminates in a continuous process in which the laminates are heated while in an oven. Thus, as a practical matter, the tendency of the bi-laminates to curl would not be a significant problem in a commercial production environment. Particularly preferred embodiments comprise at least three layers, that is, one shrink film layer sandwiched between two non-shrink film layers or one non-shrink film layer sandwiched between two shrink film layers. Additional constructions, containing more than three layers, are also contemplated and advantageous. By changing the bond patterns, the texture and appearance of the laminate can be tailored.

The physical structure of the laminate depends on the characteristics of the materials used in making the laminate, specifically, the initial thickness of the shrink film, the density of the shrink film, the amount of shrinkage of the film and the basis weight of the other layer(s) used in making the laminate. The term “basis weight” denotes the weight of the material per unit area, such as grams/m². The physical structure also depends on the periodicity of the bonding pattern and the size of the point bonds. With these six parameters, the final basis weight and number of pleats per inch can be calculated. When the number of pleats per inch exceeds a critical value—depending upon the characteristics of the non-shrink film layer—the pleats become self-supporting and will stand essentially perpendicular to the plane of the film. When this happens, the loft of the product can also be approximated.

### Shrink Film Component

The film layer of the laminate is selected from thermoplastic films and more particularly nonelastic films. The film layer may be an apertured film, an apertured formed film, a non-apertured film, or a microporous breathable film. Such films and their process of manufacture are well known to those in the hygiene art in particular. In all cases, the film should be non-elastic. Apertured and microporous films are preferred when fluid (air and/or water) permeability is important in the final laminate.

The shrink film comprises the engine that pleats the non-shrink film layer(s). Ideally, its thickness would be vanishingly small, it would shrink instantaneously when heated, and it would have high contractive force. In one embodiment, the shrink film should be low in crystallinity, highly oriented and as thin as possible.

The film layers are produced from thermoplastic polymers such as polyolefins, polyamides, polyesters, acrylic polymers, polyvinyl chloride, polyvinyl acetate, and copolymers and blends thereof. Suitable polyolefins include, for example, polyethylene, e.g., high density polyethylene, medium density polyethylene, low density polyethylene and linear low density polyethylene; polypropylene, e.g., isotactic polypropylene, syndiotactic polypropylene, blends thereof, and blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene) and polybutadiene; and copolymers and blends thereof. Suitable copolymers include random, alternating and block copolymers prepared from two or more different unsaturated olefin monomers, such as ethylene/propylene copolymers, butene/propylene copolymers, ethylene vinyl acetate and ethylene vinyl alcohol. Additionally suitable olefin copolymers include heterophasic propylene polymers disclosed in U.S. Pat. No. 5,368,927.

Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(ethylene terephthalate), poly(butylene terephthalate), poly(tetramethylene terephthalate), poly(cyclohexylene-1,4-dimethylene terephthalate), and isophthalate copolymers thereof, as well as blends thereof. Suitable acrylic polymers include ethylene methyl methacrylate and the like. Of these suitable polymers, the more desirable polymers are polyolefins, olefin copolymers and blends thereof since such polymers are widely available and have useful chemical and mechanical properties.

The most desirable polymers for the film layer are various polyethylenes, various polypropylenes, and blends and copolymers thereof. Films containing a suitable polymer can be produced in accordance with conventional methods, such as casting and blowing processes.

The film layer exhibits a higher level of latent shrinkability than the non-shrink film layer. In general, latent shrinkability is imparted in a thermoplastic material when the material is stretched to orient the polymer molecules of the material. Typically, a thin thermoplastic film is drawn or oriented to improve strength properties of the material in the oriented direction. In addition to improving strength properties, an orienting or stretching process can be used to reduce the thickness of or to down gauge the film layer material such that a more economical use of the material can be achieved.

As is known in the art, different levels of molecular orientation can be imparted in the shrink film layer by controlling the extent of stretching or drawing. In general, such reduced gauge and improved strength thermoplastic material imparts increased molecular alignment. When the oriented thermoplastic material is exposed to a temperature that is high enough to allow some degree of molecular movements, i.e., a temperature above the glass-transition temperature T_{g}, more particularly above the softening temperature, of the thermoplastic polymer, the molecules of the thermoplastic material rearrange to relieve the molecular stress and strain. As a result of the molecular movement, the thermoplastic material shrinks generally in the direction of the molecular orientation. The extent of shrinkage typically is proportional to the extent of molecular orientation imparted in the thermoplastic material.

Thin shrink films contribute less to the overall basis weight and cost of the laminate, but may not have sufficient contractive force to pleat the non-shrink layer(s), particularly those with higher basis weight. This could be partly offset by using a bonding pattern with a higher bond periodicity, thus generating fewer folds per inch in the final product. However, a smaller number of folds per inch reduces the likelihood that the pleats will be self-supporting, which could reduce the overall loft and resilience of the laminate. Thinner shrink films will tend to heat up faster, requiring less heat input to induce shrinkage. Heat uptake and shrinkage rates may be key factors that influence processing rates.

Thick shrink films provide higher contractive forces, which are desired to physically pleat the non-shrink layer(s). However, as the shrink film contracts, its basis weight increases, which can stiffen the resulting laminate. This may be partly counteracted by using a shrink film made from low crystallinity resins, such as Affinity® ultra low density polyethylene resins from Dow Chemical, Exxact® ultra low density polyethylene resins from ExxonMobil, ethylene/vinyl acetate copolymers, mixtures thereof and blends with other polymers. In addition to having low stiffness, low crystallinity films will soften and shrink at lower temperatures than higher crystallinity films.

The thickness and weight of the shrink film layer may also vary widely. However, a more desirable film layer for the laminate has a thickness between about 0.3 mil (7 μ) and about 2 mil (50 μ).

High shrinkage values of the shrink film translate into increased overall basis weight of the final laminate. High shrinkage values will also increase the final loft up to the limits imposed by the bonding pattern. High shrinkage is facilitated by high film orientation and a high molecular entanglement density. Film orientation in cast films can be increased by adopting casting conditions that increase melt extension and reduce opportunities for molecular relaxation. Examples of such casting conditions include reducing the extruder, pipe and die temperatures; increasing the width of the die gap; reducing the length of the melt curtain; and increasing the rate of quenching on the chill roll. High molecular weight with long chain branching would also be advantageous to increase film shrinkage.

Film layer materials may be breathable, i.e., the film layer has a water vapor transmission rate of at least 1000 grams per square meter for 24 hours as measured in accordance with ASTM E96-80, Method B. More desirably, the breathable film layer material also exhibits microbial barrier properties. Typically, a breathable film contains evenly distributed micropores that are large enough to pass water vapor through the pores but small and tortuous enough to prevent liquid, and desirably also prevent microbes, from flowing therethrough.

There are a number of ways to make a film breathable, which include microaperturing, solution leaching and the use of fillers. When fillers are used, a film is produced from a thermoplastic film composition that contains filler particles and then the film is stretched or crushed between rollers to crack the filler particles so as to create small gaps or apertures in the film. The term “filler” as used herein indicates particulates or other forms of materials that can be blended with a thermoplastic film composition and do not adversely interact with the film composition but can be uniformly dispersed in the film composition.

In general, the fillers are in a particulate form and have an average particle size in the range of about 0.1 μ to about 10 μ. Exemplary fillers include calcium carbonate, various kinds of clay, silica, alumina, barium sulfate, sodium carbonate, talc, calcium sulfate, titanium dioxide, zeolite, aluminum sulfate, diatomaceous earth, magnesium sulfate, magnesium carbonate, barium carbonate, kaolin, mica, carbon particles, calcium oxide, magnesium oxide, aluminum hydroxide and polysaccharide particulates, e.g., wood powder, pulp powders, chitin, chitosan and derivatives thereof. The filler material or a masterbatch of the filler material, typically, is dry blended with the thermoplastic resin pellets, e.g., in a tumble blender to uniformly distribute the filler, and then the physical mixture of the resin and the filler is processed to form a film. Again, a conventional film forming process, such as a casting or blowing process, can be used to form a film from the filled polymer composition.

A suitable composition for the breathable film of the may contain, based on the total dry weight of the composition, from about 10% to about 70% of a thermoplastic polymer and from about 30% to about 90% of a filler material. Optionally, the composition may additionally contain from about 2% to about 20% of a bonding agent. The film layer composition may also contain processing aids, heat stabilizers, antistatic agents, radiation stabilizers, light stabilizers, flame retardants, alcohol repellents, water repellents and the like.

In other embodiments, the film layer may comprise an apertured film, and more particularly a so-called three-dimensional apertured film. Such films are known from the teachings of U.S. Pat. No. 4,456,570 and U.S. Pat. No. 3,929,135 mentioned previously and are formed by subjecting a molten polymer web to vacuum while the web is supported on a forming structure. The vacuum pulls the polymer material into holes in the forming structure and causes the polymer to rupture. As the film cools, the ruptured area forms into a generally conical shaped protuberance in the film. Such films may also be made by subjecting a heat softened film to high pressure water jets while the film is supported on a forming structure. The high pressure water jets force the film into holes in the forming structure, causing the film to rupture and cool into the conical shaped protuberances. Such a process is known from the teachings of U.S. Pat. No. 4,609,518, the disclosure of which is incorporated herein by reference.

It is generally not preferred to impart breathability by using films containing a plurality of slits or die cut apertures. When heat shrunk, such films tend to buckle such that the heat shrunk film is no longer in a generally planar configuration but instead assumes an undulating or wavy film, which is not desired.

### Nonwoven Fabric Component

In a preferred embodiment, the laminates will contain at least one fibrous layer, most preferably a fibrous nonwoven fabric. As is known in the art, nonwoven webs are fibrous webs comprised of polymeric fibers arranged in a random or non-repeating pattern. For most of the nonwoven webs, the fibers are formed into a coherent web by any one or more of a variety of processes, such as spunbonding, meltblowing, bonded carded web processes, hyrdoentangling, etc., and/or by bonding the fibers together at the points at which one fiber touches another fiber or crosses over itself. The fibers used to make the webs may be a single component or a bi-component fiber as is known in the art and furthermore may be continuous or staple fibers. Mixtures of different fibers may also be used for the fibrous nonwoven fabric webs.

Suitable materials for the fabric layer include nonwoven fabrics, e.g., spunbond webs, meltblown webs, hydroentangled webs, bonded staple fiber webs and the like; woven fabrics; knits and the like. Of these, particularly preferred materials for the fibrous layer are nonwoven fabrics produced from one or more of fiber-forming thermoplastic polymers.

The nonwoven fabrics can be produced from any fiber-forming thermoplastic polymers including polyolefins, polyamides, polyesters, polyvinyl acetate and copolymers and blends thereof, as well as thermoplastic elastomers. Examples of specific polyolefins, polyamides, polyesters, and copolymers and blends thereof are illustrated above in conjunction with the polymers suitable for the film layer. Suitable thermoplastic elastomers for the fibrous layer include tri- and tetra-block styrenic block copolymers, polyamide and polyester based elastomers, and the like.

The polymer selected for the fibrous nonwoven fabric desirably has a melting point Tₘ equal to or higher than the melting point Tₘ of the polymer of the shrink film layer since it is not desirable to limit the annealing temperature of the annealing process to the melting point Tₘ of the fibrous nonwoven fabric. The fibrous nonwoven fabric layer can be produced from monocomponent fibers, multicomponent conjugate fibers, or blends of more than one type of fibers. The fibrous nonwoven fabric layer may also contain natural fibers, e.g., cotton fibers, wood pulp fibers and the like. Additionally suitable fibrous nonwoven fabrics are laminates of different nonwoven fabrics, e.g., spunbond webs, meltblown webs, hydroentangled web and bonded staple fiber webs. For example, U.S. Pat. No. 4,041,203 teaches a laminate containing at least one spunbond web and one meltblown web, which is highly useful as the fibrous nonwoven web in the present laminates.

The thermoplastic fibers can be made from a variety of thermoplastic polymers, including polyolefins such as polyethylene and polypropylene, polyesters, copolyesters, polyvinyl acetate, polyamides, copolyamides, polystyrenes, polyurethanes and copolymers of any of the foregoing such as ethylene/vinyl acetate, and the like. Suitable thermoplastic fibers can be made from a single polymer (monocomponent fibers), or can be made from more than one polymer (e.g., bicomponent fibers). For example, “bicomponent fibers” can refer to thermoplastic fibers that comprise a core fiber made from one polymer that is encased within a thermoplastic sheath made from a different polymer. The polymer comprising the sheath often melts at a different, typically lower, temperature than the polymer comprising the core. As a result, these bicomponent fibers provide thermal bonding due to melting of the sheath polymer, while retaining the desirable strength characteristics of the core polymer.

Bicomponent fibers can include sheath/core fibers having the following polymer combinations: polyethylene/polypropylene, polyethylvinyl acetate/polypropylene, polyethylene/polyester, polypropylene/polyester, copolyester/polyester, and the like. The bicomponent fibers can be concentric or eccentric, referring to whether the sheath has a thickness that is even, or uneven, through the cross-sectional area of the bicomponent fiber. Eccentric bicomponent fibers can be desirable in providing more compressive strength at lower fiber thicknesses.

In the case of thermoplastic fibers for carded nonwoven fabrics, their length can vary depending upon the particular melt point and other properties desired for these fibers. Typically, these thermoplastic fibers have a length from about 0.3 to about 7.5 cm long, preferably from about 0.4 to about 3.0 cm long. The properties of these thermoplastic fibers can also be adjusted by varying the diameter (caliper) of the fibers. The diameter of these thermoplastic fibers is typically defined in terms of either denier (grams per 9000 meters) or decitex (grams per 10,000 meters). Depending on the specific arrangement within the structure, suitable thermoplastic fibers can have a decitex in the range from well below 1 decitex, such as 0.4 decitex, up to about 20 decitex.

In order to give certain strength and integrity properties to the web structures, these are generally bonded. The most broadly used technologies are (a) chemical bonding or (b) thermal bonding by melting a part of the web. For the latter, the fibers can be compressed, resulting in distinct bonding points, which, for example for nonwoven materials, can cover a significant portion of the total area. Or, particularly useful for structures where low densities are desired, “air-through” bonding can be applied, where parts of the fibers; e.g., the sheath material of a bicomponent fibers, are partially melted by means of heated air passing through the (often air-laid) web. As the web is cooled, the partially melted fibers bond to one another where they touch.

To facilitate the production of a high loft laminate, the nonwoven fabric component should be flexible enough to pleat easily, but not so flexible that the pleats can be crushed by the compression forces likely to be experienced during use. Fibers that take a dead fold easily would be disadvantageous. Finer polypropylene fibers are less likely to take a dead fold than thicker fibers. Factors affecting nonwoven fabric flexibility include polymer stiffness, fiber diameter, basis weight of the nonwoven fabric, and the process used to manufacture the nonwoven fabric; e.g., spunbond, carded, spunbond-meltblown-spunbond (“SMS”), etc.

In embodiments where a shrink film is sandwiched between two fibrous nonwoven fabrics, it is understood that more than one layer of nonwoven fabric could be used per side of the film. Furthermore, it is not necessary that the nonwoven fabrics be the same on each side, nor that they should be the same if multiple nonwoven fabric layers are used per side. For example, nonwoven fabrics with robust fibers could be used as outer layers, while inner layers could comprise finer fibers that hold a cleaning fluid.

The overall basis weight of nonwoven fabric in the finished laminate will be a product of the contraction ratio and initial basis weight of the nonwoven fabric layers. The nonwoven fabric bonding pattern influences the local flexibility of the nonwoven fabric and hence its propensity to form pleats. High bond area, large bond points and bond points elongated along the shrinkage axis will all impede the formation of pleats.

### Other Film Components

The thermoplastic composition for the shrink film layer may additionally contain a bonding agent that facilitates improved bonding of the film layer to other layer(s) of the laminate, improving the bonding and peeling strength of the resultant laminate and lowering the temperature and pressure required to bond the laminate. The addition of the bonding agent is particularly important when the polymers of the other layer(s) and the film layer are incompatible or not highly compatible. Examples of useful bonding agents include hydrogenated hydrocarbon resins such as Regalrez® series tackifiers, which are available from Hercules, Inc., and Arkon® series tackifiers, which are available from Arakawa Chemical (U.S.A.), Inc. Other suitable bonding agents include Zonatec® 501, which is produced by Arizona Chemical Co., and Eastman® 1023 PL resin, which is available from Eastman Chemical. Yet another group of suitable bonding agents includes ethylene copolymers such as ethylene vinyl acetate, ethylene ethyl acrylate, ethylene acrylic acid, ethylene methyl acrylate and ethylene butyl acrylate. Mixtures and blends of tackifiers can also be employed.

In alternate embodiments, the shrink film layer could be bonded to one or more non-shrink film layer(s) to form a laminate. In other embodiments, a non-shrink film could be sandwiched between layers of shrink film. In such embodiments, it is only necessary that the non-shrink film have less latent shrinkability than the shrink film layer, and that the layers be of such composition that they can be physically bonded together to form a laminate.

Accordingly, cast or blown films of polyolefins, polyester, polyurethane, polyamine, or any other film-forming compositions can be employed as the non-shrink film in the present laminates.

### Laminate Structure

The physical structure of the laminate depends on certain material characteristics of the components: (1) the thickness and density of the shrink film; (2) the shrinkage of the film; (3) the basis weight of the nonwoven fabric; and (4) the ultrasonic bonding pattern and bond point size. With these parameters the final basis weight and number of pleats per inch can be accurately predicted. When the density of pleats per inch exceeds a certain value, depending upon the characteristics of the nonwoven fabric, the pleats become self-supporting and will stand essentially perpendicular to the plane of the film. When this happens the loft of the product can be approximated. In certain embodiments, the loft of the laminates is greater than 0.0125 inch and can be as high as about 0.35 inch.

The film layer and the nonwoven layer are bonded together to form the laminates. The method of bonding, bonding pattern and the bonding conditions are important parameters in making the laminates. In general, because no significant shrinkage occurs within the bond area, the bond area should be as small as possible to maximize laminate shrinkage. Line bonds oriented substantially perpendicular to the shrinkage direction would tend to stiffen the laminate parallel with their length. Line bonds oriented substantially parallel with the shrinkage direction would impede shrinkage. Point bonds provide the greatest laminate flexibility. Point bonding, such as ultrasonic bonding or thermal pressure bonding using a patterned roll and an anvil counter-roll, are preferred, but adhesive point bonding or other point or line bonding methods could also be used if desired.

The loft of a tri-laminate with a high pleat density will approach the separation length between rows of ultrasonic bond points (i.e. the bond periodicity minus the dimension of the bond points in the shrinkage direction).

For the case of a 2.0 mil thick shrink film comprising a blend of low density polyethylene and linear low density polyethylene, with a shrinkage value of 75%, two layers of nonwoven fabric each with a basis weight of 25 gsm and a hexagonal point bonding pattern with 0.015 inch diameter bond points with a row to row spacing of 0.157 inches, the resulting laminate will have a basis weight of 223 GSM, a fold periodicity of 0.051 inches, a pleat density of 19.8 pleats/inch, an uncompressed thickness of approximately 0.071 inches, and a bulk density of approximately 0.124 g/cm³.

In preferred embodiments, the pleats in the laminate are self-supporting after heat shrinking. The term “self-supporting” indicates that the pleats will remain in a generally perpendicular orientation relative to the plane of the film. In addition, it is particularly preferred that the film, once heat shrunk, remains generally planar as shown in the Figures and does not exhibit appreciable undulations or waviness.

### Process

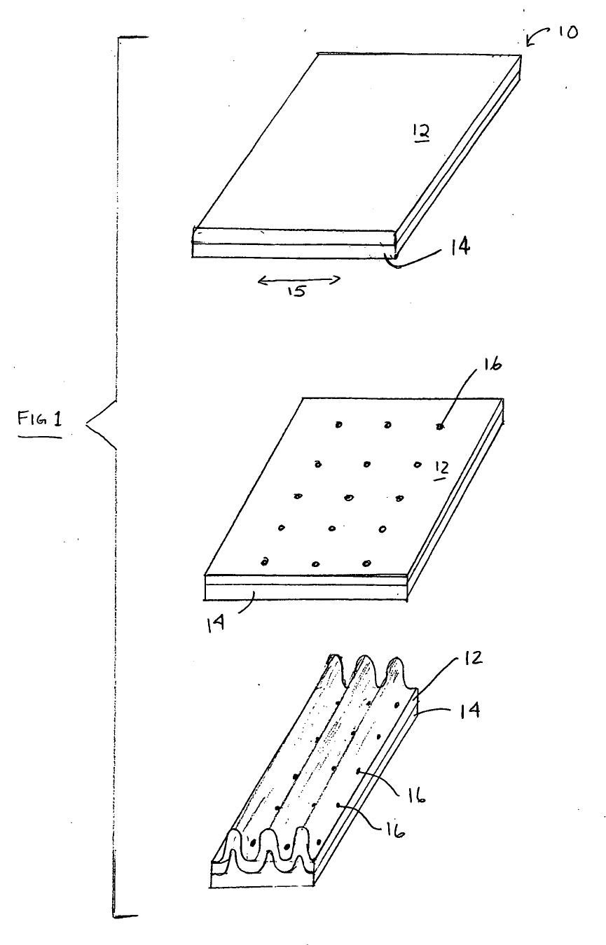

An exemplary process to produce laminates in accordance with the disclosure is illustrated schematically in FIG. 1. As seen in FIG. 1, the laminate 10 is made by first positioning a nonwoven web 12 in surface-to-surface contact with film 14.

In the embodiment shown, the film 14 has been oriented in the direction of arrow 15. The film 14 can be oriented in any manner known in the art. For example, the film 14 can be fed through a series of heated rollers to uniformly heat the film 14 to a temperature (stretching temperature) between the glass-transition temperature T_{g} and the melting point Tₘ of the polymer forming the film, more desirably between the softening temperature and the melting point Tₘ of the polymer forming the film. For example, when an ethylene polymer or propylene polymer film layer is utilized, particularly desirable stretching temperatures for the film layer are in the range between about 60° C. and about 120° C. The film 14 can then be fed into a set of stack rollers. The stack rollers are designed such that the speed of the film traveling through the stack rollers can be controlled by varying the rotational speed of the rollers. The peripheral linear speed of the first set of stack rollers is controlled to be faster than the peripheral linear speed of the heated rollers so as to apply a stretching tension to stretch and orient the molecules of the film. The peripheral linear speed of the second stack roller set is yet faster than the peripheral linear speed of the first stack roller set, sequentially further stretching and orienting the heated film 14. The film layer can be stretched to any desired level. However, it is particularly useful to stretch the layer to a length in the range between about 200% and 600% of the original length.

The stretched film 14 is then cooled desirably to a temperature in which the movement of the oriented molecules of the film is largely prevented, e.g., below the softening temperature of the film, by passing it over chill rollers.

The fibrous nonwoven fabric 12 is placed in juxtaposition with the film 14. Optionally, one or more additional layers of fibrous nonwoven fabric and/or films can be added to the laminate structure 10.

The laminate structure 10 is then bonded using a bonding process that imparts a plurality of spaced-apart bond sites or line bonds such that the layers of the laminate structure are attached to each other at the bond sites and are independently moveable at the regions between adjacent bond sites. Suitable bonding processes for the present invention include thermal pattern bonding processes, ultrasonic bonding processes and adhesive bonding processes. The type of bonding process used will depend on the nature of the materials being bonded together and the final desired properties of the laminate. However, in general, ultrasonic bonding will be preferred for many applications.

A particularly desirable bond pattern imparts bond sites throughout the laminate in a desired pattern and imparts a total bonded area less than 5%, based on the total planar surface area of the laminate, and imparts less than 250 bond sites per square inch, more preferably less than 100 bond sites per square inch, and most preferably less than 50 bond sites per square inch.

After being bonded together, the laminate is subjected to heat, which causes the non-bonded portions of the film to shrink. This results in the formation of pleats in the nonwoven fabric between the bond points. The laminates are shrunk by at least 10% of their pre-shrunk dimension, more preferably by at least 35% or their pre-shrink dimension, even more preferably by at least 50%, and most preferably at least 70% of their dimension prior to the shrinking step. For example, a laminate that is 100 mm in length before shrinkage will preferably be 75 mm, 65 mm, 50 mm or 30 mm after the heat shrink step.

In amount of heat needed to induce shrinkage in the shrink-film layer (annealing temperature) will vary depending on the particular film used and the degree of desired shrinkage. In general, however, the annealing temperature will be very near the melting temperature Tₘ of the shrink film. For example, in some embodiments, the annealing temperature may be in a range of ±10° of the melting temperature. It is highly desirable to heat the laminate to an annealing temperature that is higher than the above-discussed stretching temperature. More particularly, a suitable range for the annealing temperature is between about 5° C. and about 30° C. higher than the stretching temperature.

As mentioned above, the thermal stability of the annealed laminate is essentially stable up to the annealing temperature. Consequently, it is highly advantageous to anneal the laminate at a higher temperature, provided that the temperature is not so high as to cause a melting of any of the layers in the laminate.

During the annealing process, the shrinkage of the film layer causes the fibrous layer, which has a lower latent shrinkage than the film layer, to gather and bulk up between adjacent bond sites, forming a three dimensional texturized laminate and improving the textural properties of the laminate. It is important to note that the size of each bond site, the total number of the bond sites and the distance between adjacent bond sites affect the extent of the three dimensional texturization. For example, one of controlling factors for the extent of texturization, i.e., the level of bulking up, of the laminate is the distance between adjacent bond sites provided that the film layer has a sufficient level of molecular orientation to accommodate such shrinkage. The annealed laminate is then cooled to a temperature at which the gross movement of the molecules of the film is largely prevented, e.g., below the softening temperature of the film. The resulting annealed laminate is three dimensionally texturized and thermally stable, and the laminate exhibits highly desirable textural and visual properties.

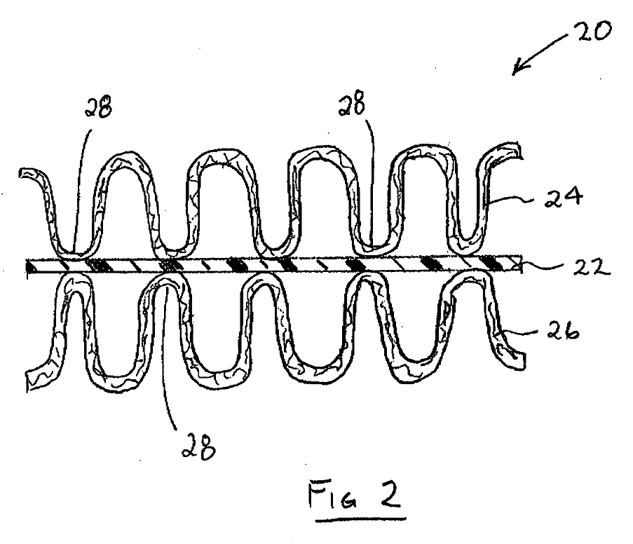

FIG. 2 illustrates a trilaminate in accordance with the disclosure, comprising a laminate 20 having a film layer 22. A fibrous web, such as nonwoven webs 24 and 26, are bonded to opposite surfaces of the film 22, such as by a plurality of bond points 28. The laminate 20 is made in the same manner as laminate 10 depicted in FIG. 1 and forms a texturized, pleated laminate as described above.

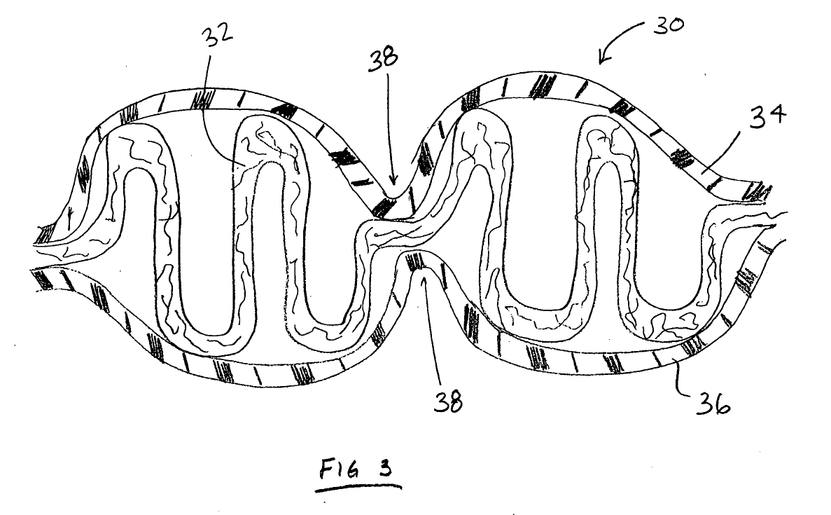

In FIG. 3, another embodiment of the laminate 30 is depicted. In this embodiment, a fibrous layer 32 is sandwiched between two film layers 34, 36 and bonded thereto by a plurality of bond points 38. Laminates having the general construction as shown in FIG. 3 are particularly advantageous when the loft and/or cushioning of the laminate is desired, but it is not desirable for the fibrous layer to be exposed (e.g., because of contamination concerns from stray fibers).

The present laminate production process is not limited to the above-described machine direction (MD) stretching and MD relaxing process. The film layer can be stretched and the laminate can be relaxed in cross-machine direction (CD) using, for example, a tenter frame. Additionally, the laminate production process can be modified to apply biaxial, i.e., both CD and MD, stretching and relaxing steps to provide a highly and multidirectional texturized laminate. The film layer can be separately stretched and subsequently used to form the laminate, or the laminate can be made in a continuous process. Alternatively, commercially available uniaxially or biaxially oriented films can be utilized, provided that the latent shrinkage of the films is higher than the latent shrinkage of the fibrous layer.

Shrinkage must take place under conditions in which the laminate can change length freely, i.e. the laminate must be unsupported or in contact with a low friction surface. It is also advantageous for the shrinkage temperature must be sufficiently high that shrinkage takes place rapidly. This will eliminate the tendency for the laminate to sag and will facilitate manufacturing at commercial rates. Thick nonwoven layers will tend to insulate the shrink film and thus delay the onset of shrinkage and reduce its rate.

High shrink values result in slower production rates (at the winder) due to deceleration of the film during shrinkage. The winder speed will be a fraction of the casting chill roll speed. In order to minimize the length of the heat tunnel, shrinkage must take place rapidly. For example, assuming a contraction ratio of 4×, an incoming laminate speed of 400 fpm, negligible temperature rise time in the oven (i.e. instantaneous heating) and a shrinkage time of 15 seconds, the shrink tunnel would have to over 60 feet long. A shrinkage time of 5 seconds would reduce the tunnel length to approximately 20 feet.

Relying on the conductivity of hot air in the oven to heat the laminate may require excessive exposure times, especially when the nonwoven layers are thick. Thus, additional or alternate methods of heating the laminate may be employed. For example, pre-heating the laminate in a roll stack comprised of a series of heated rollers would reduce the time in the oven required to bring the film up to the shrinkage temperature. Radiative heating just inside the oven would also help reduce the heating time. Conceivably an infra-red radiation or microwave absorber could be incorporated into the film to accelerate heating. Inductive heating might also be used if the film were to contain polar groups, such as vinyl acetate co-monomers. Thin films will heat up faster than thick ones. In some embodiment, the laminate may be heated without the use of an oven, such as by use of a heated roll stack alone. Selection of the appropriate method will be within the skill of the ordinary artisan based on desired production rates and available space in the manufacturing environment, and other factors.

The texturized laminate can have widely different levels of texturization, from low to high texturization. Such variation in texturization can be accomplished by, for example, utilizing film layers that have different levels of molecular orientation, applying different annealing temperatures and varying the duration of the annealing process. In general, a film layer having a high level of molecular orientation provides a highly texturized laminate, and utilizing a high annealing temperature and/or extending the annealing duration also provides a highly texturized laminate. Additionally, as discussed above, the texturization level can be controlled by utilizing different bond patterns. The present annealing texturization process is highly advantageous in that the laminate can be texturized to a level that is highly difficult with prior art attempts.

### INDUSTRIAL APPLICABILITY

The laminates produced in accordance with the disclosure are relatively stiff compared to conventional, non-heat shrunk laminates and have self-supporting pleats. They are advantageously used for a variety of applications, including as wipes for hard surface cleaning scrubbing pads for household cleaning, skin wipes where enhanced scrubbing ability is desired, dusting mitts and dust mop covers. Another application for the laminates is as filtration media for gasses of liquids. Because these laminates can be produced with densities similar to those of expanded polystyrene, yet another potential application is as an insulation batts for flooring and walls, blown in insulation where heated air is used to both transport the laminate and shrink the film, and insulative wrapping for pipes and other irregular shaped objects. The laminates also have application in upholstery (as, for example, mattress, pillow and cushion covers); in medical applications (as, for example, cushioned disposable bed pads); erosion control webs; oil-absorbing floor pads; and cushioned packaging. Still another application of the laminates, particularly those comprising a fibrous layer sandwiched between two shrink film layers, would be in separating and protecting delicate surfaces, such as optical quality substrates of glass or plastic used in the manufacture of plasma screen, LCD displays and other electronic devices.

In addition, it has been discovered that laminates made according to the disclosure produce nonwovens that have unique features. More specifically, after making the laminate, the nonwoven(s) can be removed from the film. The nonwoven web(s) have a very uniform creped structure and demonstrate remarkable form elasticity (i.e., elastic properties caused by the structure of the web as opposed to its chemical composition). In particular, the nonwoven web(s) can stretched in some embodiments, to at least 150% and will spontaneously return to their original size.

### EXAMPLES

The following examples are provided for illustration purposes and the invention is not limited thereto.

### Example 1

A 0.59 mil thick shrink film comprising a blend of low density polyethylene and a plastomer resin having a density of 0.896 g/cm³ was laminated to two layers (one nonwoven layer on each side of the film) of a SofSpan® 200 nonwoven fabric (BBA Fiberweb). The nonwoven fabric comprised fibers of a blend of polyethylene and polypropylene with a basis weight of 25 gsm. The film and nonwoven layers were ultrasonically bonded together using a bond pattern with rows of bond points 0.039 inch in diameter with a row-to-row periodicity of 0.111 inch. After bonding, the laminate was heated in a 130° C. oven for 28 seconds. The resulting texturized laminate is reduced in length by 50% in the principal shrink direction and 7% in the perpendicular direction as compared to its pre-shrunk dimension. The laminate had a basis weight of 138 gsm and a nominal thickness of 0.121 inch with approximately 18 pleats per inch on either side and a calculated bulk density of 0.045 g/cm³.

### Example 2

A 2.05 mil thick shrink film comprising a blend of low density polyethylene and a plastomer resin having a density of 0.896 g/cm³ was laminated to two layers of a SofSpan® 200 nonwoven fabric (BBA Fiberweb). The nonwoven fabric comprised fibers of a blend of polyethylene and polypropylene with a basis weight of 25 gsm. One nonwoven layer was positioned on each surface of the film layer. The film and nonwoven layers were ultrasonically bonded together using a bond pattern with rows of bond points 0.034 inch in diameter with a row-to-row periodicity of 0.394 inch. After bonding, the laminate was heated in a 130° C. oven for 39 seconds. The resulting texturized laminate was reduced in length by 68% in the principal shrink direction and 7% in the perpendicular direction based on its pre-shrunk dimensions. The laminate had a basis weight of 331 gsm and a nominal thickness of 0.326 inch with approximately 8 pleats per inch on either side and a calculated bulk density of 0.040 g/cm³.

### Example 3

A 0.96 mil thick shrink film comprising low density polyethylene having a density of 0.924 g/cm³ is laminated to two layers of a 15 gsm spun bond FPN 639 polypropylene nonwoven fabric (BBA Fiberweb). One layer of the nonwoven fabric was placed on either side of the film layer and all three layers were ultrasonically bonded together using a bond pattern having rows of bond points 0.039 inch in diameter with a row-to-row periodicity of 0.158 inch. The laminate was placed in a 140° C. oven for 23 seconds. The resulting texturized laminate had a basis weight of 129 gsm and a nominal thickness of 0.140 inch with approximately 15.5 pleats per inch on either side and a calculated bulk density of 0.036 g/cm³.

1. A laminate comprising a non-elastic film layer and at least one other layer bonded to the film layer by a plurality of spaced-apart bond points, wherein said non-elastic film layer comprises a heat-shrunk film having no more than 90% of its pre-shrunk dimension, and wherein the at least one other layer comprises pleats.

2. The laminate of claim 1, wherein the at least one other layer comprises a fibrous nonwoven fabric.

3. The laminate of claim 1, wherein the at least one other layer comprises a film having a lower latent shrinkability than said non-elastic film layer.

4. The laminate of claim 1 where in said laminate comprises a fibrous nonwoven layer disposed between two heat shrunk film layers.

5. The laminate of claim 1, wherein the laminate comprises a heat shrunk film layer disposed between two fibrous nonwoven layers.

6. The laminate of claim 1, wherein the pleats are self-supporting pleats.

7. The laminate of claim 1 wherein said non-elastic film is breathable.

8. The laminate of claim 7, wherein the breathable film is selected from microporous breathable films and three-dimensional apertured films.

9. A method comprising
a) bonding a non-elastic film layer to at least one other layer by a plurality of spaced-apart bond points to form a laminate;
b) heating the laminate to shrink the film layer by at least 10% in at least one direction from its pre-shrunk dimension and thereby forming pleats in the at least one other layer.

10. The method of claim 9, wherein the at least one other layer comprises a fibrous nonwoven fabric.

11. The method of claim 9, wherein the at least one other layer comprises a film having a lower latent shrinkability than said non-elastic film layer.

12. The method of claim 9, wherein said laminate comprises a fibrous nonwoven layer disposed between two heat shrunk film layers.

13. The method of claim 9, wherein the laminate comprises a heat shrunk film layer disposed between two fibrous nonwoven layers.

14. The method of claim 9, wherein the film layer is shrunk by at least 25% in at least one direction from its pre-shrunk dimension.

15. The method of claim 9, wherein the film layer is shrunk by at least 35% in at least one direction from its pre-shrunk dimension.

16. The method of claim 9, wherein the film layer is shrunk by at least 50% in at least one dimension from its pre-shrunk dimension.

17. The method of claim 9, wherein the film layer is shrunk by at least 70% in at least one direction from its pre-shrunk dimension.

18. The method of claim 9, wherein the pleats are self-supporting.

19. The method of claim 9, wherein the non-elastic film is breathable.

20. The method of claim 19, wherein the breathable film is selected from microporous breathable films and three-dimensional apertured films.
